(19) United States
(12) Patent Application Publication
(10) Pub. No.: US 2010/0325929 A1
(43) Pub. Date: Dec. 30, 2010

(54) Emergency Kiosk Device and System

(76) Inventor: Andre Favron, Mississauga (CA)

Correspondence Address: ELIAS BORGES, 56 Aberfoyle Crescent, Suite 840, Canada, ON, M8X2W4, CA

(21) Appl. No.: 12/749,982

(22) Filed: Mar. 30, 2010

Related U.S. Application Data
(60) Provisional application No. 61/164,693, filed on Mar. 30, 2009.

(51) Int. Cl. A47G 1/06; G09F 3/00; A47G 1/16; G09F 3/10; G08B 17/10

(52) U.S. Cl. 40/638; 40/700; 40/299.01; 40/745; 40/714; 340/628

(57) ABSTRACT

The present invention is a system for assisting rescue personnel attending a residential building having an entry way and residents living therein. The system includes an information kiosk mountable to a wall inside the building. The kiosk has a base portion mountable to the wall and a decorative picture frame mounted to the base portion. The kiosk further includes an information sheet mounted between the picture frame and the base portion, the information sheet containing a plurality of fields for recording information about the residential building and the residence there in. The system also includes a reflective sticker mountable on an outside surface of the building, said reflective sticker having indicia indicating that the kiosk is mounted to a wall inside the building adjacent the entry way.

### CROSS REFERENCE TO RELATED APPLICATION

This application claims priority from U.S. provisional patent application Ser. No. 61/164,693 entitled Emergency Kiosk Device and System, filed Mar. 30, 2009, the entirety of which is incorporated herein by reference.

### FIELD OF THE INVENTION

The invention relates generally to emergency kiosks for guiding rescue personnel attending a building where an emergency situation is occurring.

### BACKGROUND OF THE INVENTION

Fire alarms are an important warning device which provides home owners and residents of commercial and residential buildings with ample warning in the event of a fire. Similar alarms are also available to detect the accidental emission of carbon monoxide gas resulting from a gas leak. When triggered by smoke, ionized air or carbon monoxide emissions, these alarm devices will sound a loud and piercing siren, warning the residents (occupants) of the property to exit the building. In some cases, in addition to a loud warning siren, the alarm device may be provided with a light which engages when the siren is sounded to help the occupants orient themselves when trying to flee the building.

Fire fighters and other rescue personnel who attend at the building where an emergency situation is occurring, such as a fire or a gas leak, are generally provided with very little information concerning the building and the occupants there in. These rescue personnel must enter the building, usually through the front door, and then search through the building in hopes of finding any individuals who have not exited the building. This is a dangerous procedure, particularly if there is a fire with large amounts of thick smoke. Since the rescue personnel do not know how many individuals may reside in the building, they have little choice but to search the entire premises. If the rescue personnel were provided with additional information about the location they were investigating, particularly the floor plan and the number of people normally resident in the building, then they would be far better prepared to handle the emergency situation and perform their rescue duties.

### SUMMARY OF THE INVENTION

In accordance with one aspect of the present invention, there is provided a system for assisting rescue personnel attending a building having residents. The system includes an information kiosk mounted to a wall inside the building and adjacent to an entry way into the building. The kiosk has a base portion mountable to the wall and a picture frame mounted to the base portion. The kiosk further includes an information sheet mounted between the picture frame and the base portion, the information sheet containing information about the building and the residents therein.

In accordance with another aspect of the present invention, there is provided a system for assisting rescue personnel attending a residential building having an entry way and residents living therein. The system includes an information kiosk mountable to a wall inside the building. The kiosk has a base portion mountable to the wall and a decorative picture frame mounted to the base portion. The kiosk further includes an information sheet mounted between the picture frame and the base portion, the information sheet containing a plurality of fields for recording information about the residential building and the residents there in. The system also includes a reflective sticker mountable on an outside surface of the building, said reflective sticker having indicia indicating that the kiosk is mounted to a wall inside the building adjacent the entry way.

With the foregoing in view, and other advantages as will become apparent to those skilled in the art to which this invention relates as this specification proceeds, the invention is herein described by reference to the accompanying drawings forming a part hereof, which includes a description of the preferred typical embodiment of the principles of the present invention.

### DESCRIPTION OF THE DRAWINGS

FIG. 1 is a front exploded view of an information kiosk made in accordance with the present invention.

FIG. 2 is a back exploded view of the information kiosk shown in FIG. 1.

FIG. 3 is a side view of the information kiosk shown in FIG. 1.

FIG. 4 is a front perspective view of the base portion of the information kiosk shown in FIG. 1.

FIG. 5 is an expanded view of portion A of FIG. 4.

FIG. 6 is an exploded view of the sticker portion of the present invention.

FIG. 7 is a front view of the sticker portion of the present invention.

FIG. 8 is a schematic representation of a residential building having the sticker portion of the present invention mounted to an outside surface of the residential building.

In the drawings like characters of reference indicate corresponding parts in the different figures.

### DETAILED DESCRIPTION OF THE INVENTION

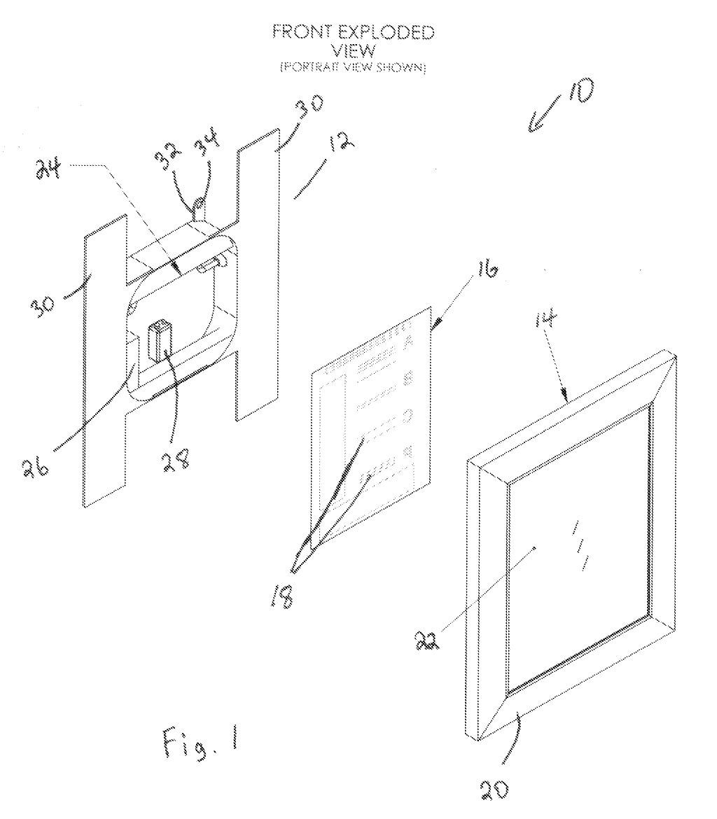

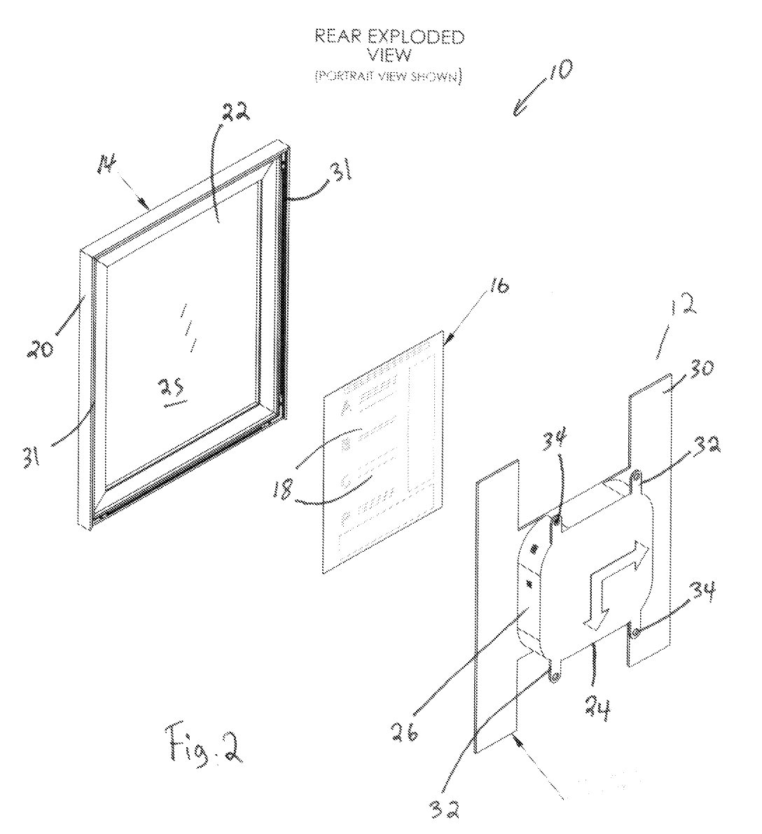

Referring firstly to FIG. 8, the system of the present invention includes an information kiosk 10 which is mounted inside a residential building 58 very near doorway 60, preferably within about seven feet from the doorway. An identification sticker 44 is mounted to the outside of the building immediately adjacent door 60. Sticker 44 acts as a signal to emergency personnel attending the residence that the information kiosk 10 is positioned inside the building within a few feet of door 60. Referring now to FIGS. 1 and 2, the kiosk portion of the present invention is shown generally as item 10 and includes a base portion 12, a picture frame 14 mountable to the base portion and an information sheet 16. Information sheet 16 has a plurality of fields 18 upon which a user or home owner may write down details about the residence and the people residing in the residence. Additional information such as a floor plan of the residence may also be included on information sheet 16. Picture frame 14 is essentially a standard picture frame having a decorative frame portion 20 and a glass screen 22. Picture frame 14, being essentially a standard picture frame, is configured to receive and display a standard decorative picture or photograph. Therefore, when kiosk 10 is mounted to a wall with in a residential building, it will look like an ordinary picture frame holding a decorative picture, print or family photograph.

Base portion 12 is provided with a housing 24 which houses a standard smoke alarm 26 (see FIG. 1) which is configured to sound an audible and distinctive alarm when smoke is detected. Smoke alarm 26 is powered by battery 28 just like any other standard smoke detector. Base portion 12 also has arms 30 which are configured to mount to frame 20 of picture frame 14. Arms 30 help to position information sheet 16 on the back surface 25 of picture frame 14. As best seen in FIG. 2, arms 30 are preferably configured to snap fit within groove 31 formed on the back of frame 20, although other suitable means for mounting picture frame 14 to arms 30 can be used, such as hook and loop fasteners, tongue and groove fasteners or the like. Preferably picture frame 14 is mounted to base portion 12 via some quickly releasable means such that the picture frame is securely mounted to the base portion but can be disassembled quickly in an emergency simply by pulling the frame off the base portion with no more than manual effort. When base unit 12 is pulled off picture frame 14, information sheet 16 is exposed and can be read.

Base portion 12 has a plurality of mounting elements 32 for mounting the base portion to an interior wall. Mounting elements 32 each have an aperture 34 for receiving a screw or other fastener. As better seen in FIG. 3, screws 38 secure mounting elements 32 to surface 36 of interior wall 35 and thereby mount kiosk 10 such that picture frame 14 is mounted slightly away from wall 35. Since the picture frame is positioned away from the wall, it is easier for a gloved hand to grasp the picture frame and pull the kiosk away from the wall. When mounted to a wall, kiosk 10 looks very much like a standard picture frame and would not look out of place in a home.

Base unit 12 has a built in smoke detector which has one or more speakers 39 for sounding a loud audible alarm when the smoke detector detects the presence of smoke. Preferably the smoke alarm contained in kiosk 10 has a very distinctive alarm which is different than any other smoke alarm. This permits residents in the house to locate the approximate position of the kiosk simply by hearing the distinctive audible alarm. Since the kiosk is positioned adjacent a main doorway out of the home, the residents can be guided to the exit simply by following the sound of the alarm. In addition, lights 40 are positioned on base member 12 and coupled to the smoke alarm such that when the alarm is triggered, lights 40 turn on and illuminate a portion of wall 35 adjacent kiosk 10. Again, since the kiosk is to be mounted adjacent an entry point to the building, the lights act as a guide helping residents find the exit. Furthermore, kiosk 10 is preferably mounted to wall 35 at the height a normal picture frame is hung, i.e. about 5 to 7 feet from the floor and well below the ceiling. In the event of a fire, smoke will tend to accumulate at the ceiling. While positioning kiosk 10 several feet below the ceiling may make the smoke alarm in the kiosk less sensitive, the illumination provided by lights 40 will be more clearly visible when the alarm is activated because the kiosk will be out of the thickest part of the smoke.

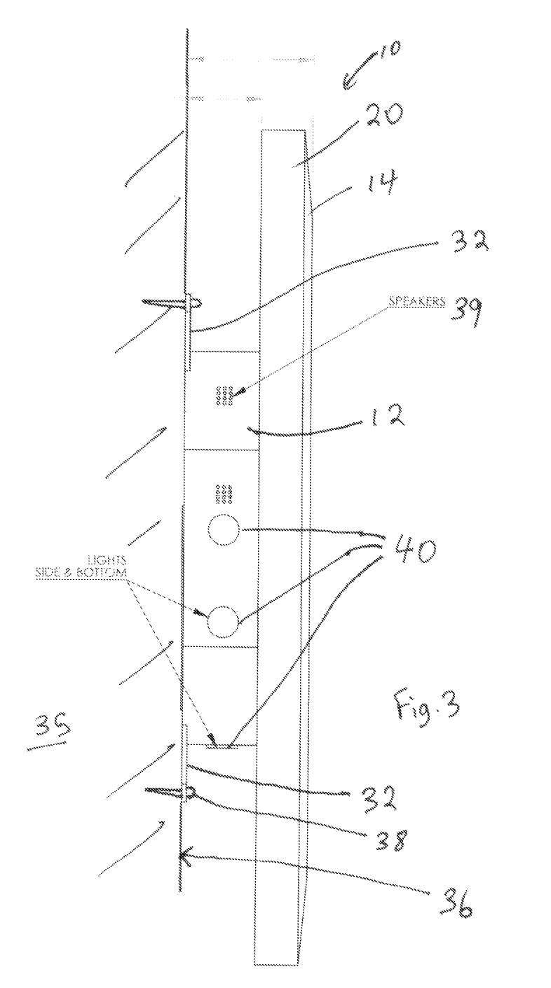

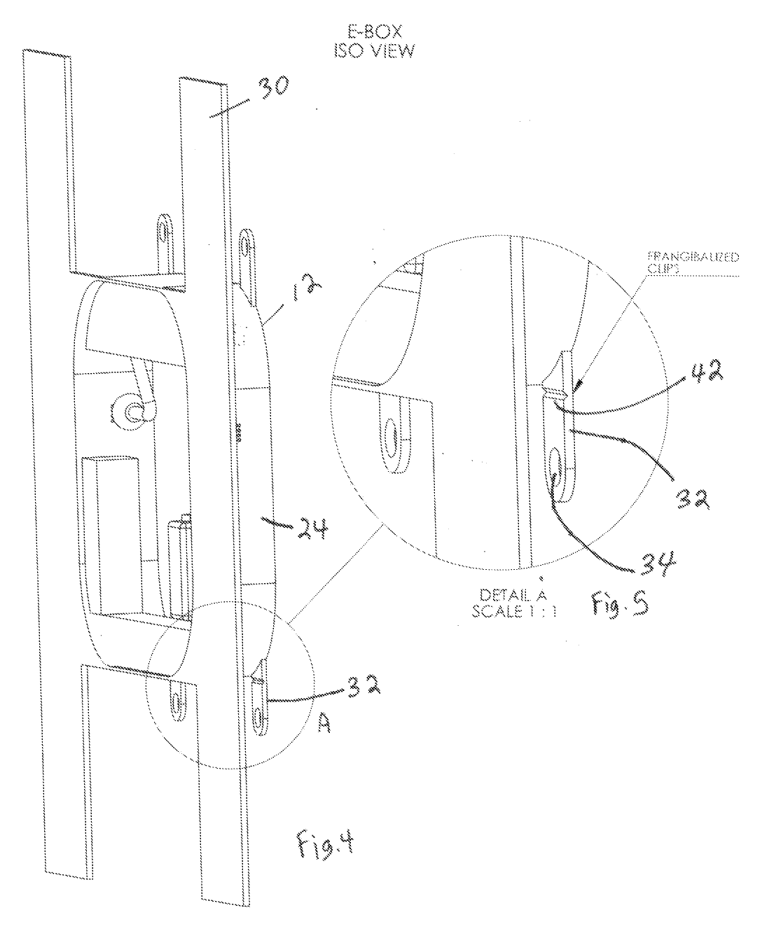

Referring now to FIGS. 4 and 5, mounting elements 32 on base unit 12 each have aperture 34 to permit the mounting elements to be secured to a wall by a fastener (screw). Each mounting element has a frangible line 42 formed thereon which will permit the mounting element to break away from the base portion when the kiosk is pulled off the wall. This makes it easier for an emergency worker, such as a fire fighter, to pull the kiosk off the wall in the event of an emergency. This easy release feature is important since a fire fighters hands may be covered with gloves making his or her grip more awkward.

Referring now to FIGS. 6, 7 and 8, the system of the present invention further includes identification sticker 44 which is mounted to an external surface 62 on the outside of a residential building 58 immediately adjacent passage way (door) 60. Sticker 44 has a highly reflective surface 54 with one or more indicia 56 indicating that information kiosk 10 is mounted on an internal wall with residence 58 no more than about seven feet or so from passage way 60. The indicia could be printed words or a logo, trademark or other symbol which indicates to trained rescue personnel that the information kiosk is mounted on an interior wall adjacent opening 60.

Sticker 44 takes the form of a dual layered sticker having base layer 46 and top layer 52. Base layer 46 and top layer 52 form separate stickers which are stuck together, one on top of the other. Base layer 46 has an adhesive side 50 which is treated with an adhesive configured to permit the sticker to remain permanently stuck on an exterior surface of the residence. Suitable adhesive stickers for use in forming base layer 46 are readily available in the market. Base layer 46 has a non-reflective surface 48. Stuck onto surface 48 is top layer 52. Top layer 52 has a reflective surface 54 on one side and an adhesive surface 56 on the opposite side. Reflective surface 54 is brightly colored and configured to reflect light such that the sticker will glow brightly in the dark when illuminated by a flash light. Suitable reflective stickers which can be used to form top layer 52 are readily available on the market.

The system of the present invention will now be discussed with reference to FIGS. 8, 3 and 1. Referring firstly to FIG. 1, a home owner or resident purchases kiosk 10 and fills out information sheet 16 with information on the people residing in the home. For example, the genders and approximate ages of the residence can be recorded on information sheet 16. Sheet 16 can also include fields for recording the location of the bedrooms in the house. The resident or home owner may even include a schematic floor plan or building layout on sheet 16. Additional information such as the location of propane tanks, ammunition and other potentially hazardous items can be included in the information sheet. Once sheet 16 is filled out, kiosk 10 is assembled. As seen in FIG. 3, kiosk 10 is then mounted to an interior wall of the house. Picture frame 14 acts as a standard picture frame displaying a family photograph or other decorative picture. Hence, kiosk 10 does not look like a piece of emergency equipment, but appears to be nothing more than a decorative item. Referring now to FIG. 8, the resident or home owner then attaches sticker 44 to the outside of the house immediately adjacent the front door or main entry way into the residence. Kiosk 10 is mounted a few feet from the door.

In the event of a fire or other emergency situation, the police or fire department may be dispatched to attend at residence 58 and deal with the emergency. In the even it is night time, the fire fighters, or other emergency personnel, will use their flash lights to aid them in approaching the residence. Sticker 44 is prominently displayed immediately adjacent passage way (door) 60 and will be clearly visible to the emergency personnel even in the dark. Upon seeing sticker 44 and the insignia there on, the emergency personnel will be cognizant of the fact that kiosk 10 is located inside residence 58 no more than a few feet from door 6. The emergency personnel make their way through door 60 and immediately scan the walls for kiosk 10. Referring back to FIG. 1, once the emergency personnel have located kiosk 10 they pull it off the wall by simply grabbing picture frame 14 and pulling sharply. This will cause the kiosk to dislodge from the wall allowing the emergency personnel to gain access to information sheet 16. The emergency personnel can then read the information contained on the information sheet to determine how many people have to be rescued from the home. In the event that not everyone listed in the information sheet can be accounted for, the emergency personnel will know to continue the search.

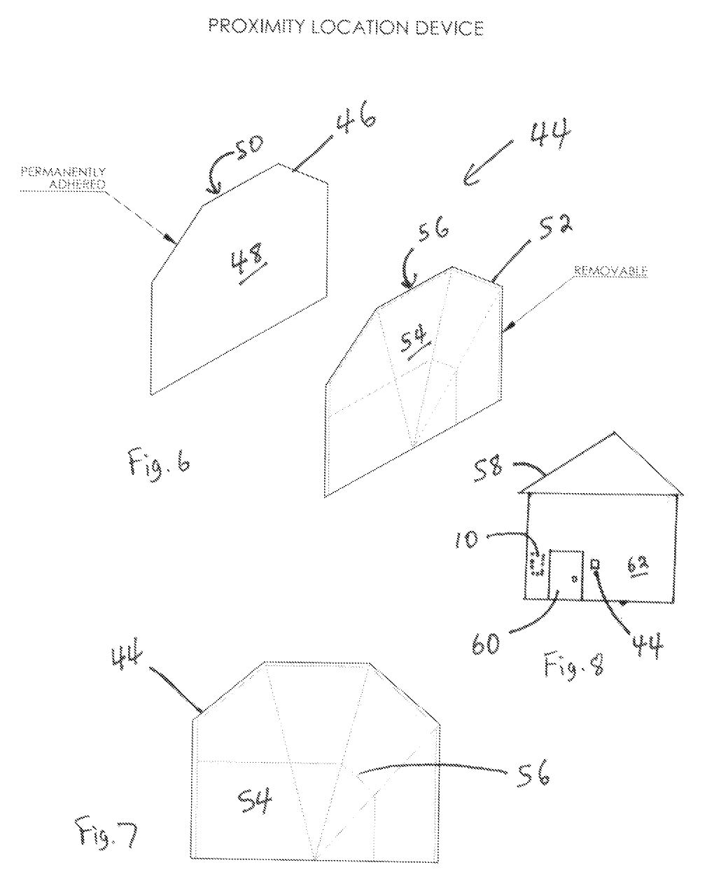

Referring back to FIGS. 6 and 7, in the event the home owner moves away from the residence and the building no longer has an information kiosk 10 mounted therein, the home owner can simply remove the top layer of sticker 44 before he or she leaves. This causes non-reflective surface 48 to be exposed. Since the surface is non-reflective, it will not attract the attention of the emergency personnel and they will therefore know not to look for an information kiosk. Non-reflective surface 44 may also have a message thereon indicating that the information kiosk contained in the house is no longer there.

The present invention has several advantages over the prior art. Firstly, it acts as a decorative ornament which would not be out of place in a residential home. The decorative nature of the kiosk increases the likelihood that people will mount the kiosk in their homes. The kiosk also provides vitally useful information to emergency personnel at a time of greatest need. Furthermore, since the kiosk is positioned adjacent an exit, the kiosk acts as a guide helping residents escape the building.

A specific embodiment of the present invention has been disclosed; however, several variations of the disclosed embodiment could be envisioned as within the scope of this invention. It is to be understood that the present invention is not limited to the embodiments described above, but encompasses any and all embodiments within the scope of the following claims.

Therefore, what is claimed is:

1. A system for assisting rescue personnel attending a building having residents, said building having an entry way, the system comprising:
an information kiosk mounted to a wall inside the building and adjacent to the entry way;
the kiosk having a base portion mountable to the wall and a picture frame mounted to the base portion;
the kiosk further comprising an information sheet mounted between the picture frame and the base portion, the information sheet containing information about the building and the residents therein.

2. The system of claim 1 wherein the information sheet is mounted to a back of the picture frame.

3. The system of claim 1 wherein the base portion has a smoke detector therein, said smoke detector configured to activate an audible alarm when the smoke detector senses smoke.

4. The system of claim 1 further comprising a reflective sticker mounted on an outside surface of the building immediately adjacent the entry way, said reflective sticker having indicia indicating that the kiosk is mounted to the wall inside the building adjacent the entry way.

5. The system of claim 1 wherein the base portion has a plurality of mounting elements formed thereon, said mounting elements each having an aperture through which the mounting element may be secured to the wall by a fastener, said mounting elements each having a frangible line configured to separate the mounting element from the base portion when the kiosk is forced off the wall.

6. The system of claim 4 wherein the base portion has a smoke detector therein, said smoke detector configured to activate an audible alarm when the smoke detector senses smoke.

7. The system of claim 6 wherein the base portion includes at least one light for illuminating a portion of the wall when the alarm is activated.

8. The system of claim 6 wherein the base portion has a plurality of mounting elements formed thereon, said mounting elements each having an aperture through which the mounting element may be secured to the wall by a fastener, said mounting elements each having a frangible line configured to separate the mounting element from the base portion when the kiosk is forced off the wall.

9. The system of claim 8 wherein the base portion includes at least one light for illuminating a portion of the wall when the alarm is activated.

10. The system of claim 4 wherein the sticker has a top layer adhered to a base layer, the base layer having an adhesive surface for mounting the sticker to the outside surface, the top layer have a reflective surface with the indicia there on, the top layer being configured to be peeled away from the base layer to reveal a non-reflective surface on the base layer.

11. The system of claim 8 wherein the sticker has a top layer adhered to a base layer, the base layer having an adhesive surface for mounting the sticker to the outside surface, the top layer have a reflective surface with the indicia there on, the top layer being configured to be peeled away from the base layer to reveal a non-reflective surface on the base layer.

12. A system for assisting rescue personnel attending a residential building having residents therein, said building having an entry way with an outside surface immediately adjacent thereto, the system comprising:
an information kiosk mountable to a wall inside the building;
the kiosk having a base portion mountable to the wall and a picture frame mounted to the base portion;
the kiosk further comprising an information sheet mounted between the picture frame and the base portion, the information sheet containing a plurality of fields for recording information about the residential building and the residence there in, and
a reflective sticker mountable on the outside surface, said reflective sticker having indicia indicating that the kiosk is mounted to a wall inside the building adjacent the entry way.

13. The system of claim 12 wherein the base portion has a smoke detector therein, said smoke detector configured to activate an audible alarm when the smoke detector senses smoke.

14. The system of claim 13 wherein the base portion includes at least one light for illuminating a portion of the wall when the alarm is activated.

15. The system of claim 12 wherein the base portion has a plurality of mounting elements formed thereon, said mounting elements each having an aperture through which the mounting element may be secured to the wall by a fastener, said mounting elements each having a frangible line configured to separate the mounting element from the base portion when the kiosk is forced off the wall.

16. The system of claim 13 wherein the base portion has a plurality of mounting elements formed thereon, said mounting elements each having an aperture through which the mounting element may be secured to the wall by a fastener, said mounting elements each having a frangible line configured to separate the mounting element from the base portion when the kiosk is forced off the wall.

17. The system of claim 12 wherein the sticker has a top layer adhered to a base layer, the base layer having an adhesive surface for mounting the sticker to the outside surface, the top layer have a reflective surface with the indicia there on, the top layer being configured to be peeled away from the base layer to reveal a non-reflective surface on the base layer.
